(19) United States
(12) Patent Application Publication
(10) Pub. No.: US 2014/0364159 A1
(43) Pub. Date: Dec. 11, 2014

(54) System and Method for SMS Private Number Routing

(71) Applicant: Numerex Corp., Atlanta, GA (US)

(72) Inventors: Thomas Murray, Atlanta, GA (US); Michael Criscolo, Alpharetta, GA (US); Steven Baker, Johns Creek, GA (US)

(73) Assignee: Numerex Corp., Atlanta, GA (US)

(21) Appl. No.: 14/298,425

(22) Filed: Jun. 6, 2014

Related U.S. Application Data
(60) Provisional application No. 61/832,557, filed on Jun. 7, 2013.

(51) Int. Cl. H04W 4/14

(52) U.S. Cl. CPC H04W 4/14
USPC 455/466

(57) ABSTRACT

A system and method of sending a message to a cellular device having a non-dialable number is described. The system and method can use a standard cellular short code, and by associating the consumer handset with one or more M2M cellular subscriptions/devices enable communications between handsets and private M2M devices. The consumer handset sends an SMS to a short code which is delivered to an SMS Private Routing mechanism which then uses a pre-assigned association between the handset and the M2M device to route the SMS to the M2M cellular device using the private phone number.

### CROSS REFERENCE TO RELATED INFORMATION

This application claims the benefit of U.S. Provisional Patent Application No. 61/832,557, filed Jun. 7, 2013, titled, “System and Method for SMS Private Number Routing”, the contents of which are hereby incorporated herein in its entirety.

### TECHNICAL FIELD

The present disclosure is directed to machine-to-machine communications using private number routing, and more particularly to a system for sending traditional SMS messages from a mobile device to an M2M device using a private number.

### BACKGROUND OF THE INVENTION

Many of today's electronic devices, sensors, monitors, and other similar equipment are designed to communicate with other devices or a central monitoring center or network. Often these communications rely on the cellular network since the devices are normally not near wired connections or are mobile. It is common in these machine-to-machine (M2M) deployments to assign private, non-dialable phone numbers to such cellular subscriptions to reduce reliance on a finite, limited set of available dialable phone numbers, and also for added security to prevent un-desired short-message-service (SMS) messages, commonly referred to as SPAM, being sent to M2M devices from unknown or undesired senders. In order to send SMS or other messaging protocol to devices with private phone numbers, it is required that a system or mechanism connect to the specific carrier via a direct, private programmatic interface (web service or SMPP).

The Short Message Peer-to-Peer (SMPP) is an open, industry standard protocol designed to provide a flexible data communication interface for the transfer of short message data between External Short Messaging Entities (ESME), Routing Entities (RE), Message Centers. These interfaces are not directly available to consumer handsets so there is no method to send an SMS message directly from a handset to an M2M device using private numbers.

### BRIEF SUMMARY OF THE INVENTION

According to the concepts described herein, a preferred embodiment of a method of sending a message to a remote cellular device having a non-dialable number is described. The method includes associating a user handset with one or more remote cellular devices having a non-dialable number, and receiving a message from the handset intended for one of the remote cellular devices at a private routing mechanism. The method then verifies the association of the handset with the intended one of the remote cellular devices, and routes the message to the intended one of the remote cellular devices using the association between the handset and the remote cellular device using the private phone number.

In another preferred embodiment a private routing mechanism for sending a message to a remote cellular device having a non-dialable number is described. The private routing mechanism includes a device mapping database storing associations between a user handset and one or more remote cellular devices each having a non-dialable number. The private routing mechanism is operable to receive a message from the handset intended for one of the remote cellular devices at a private routing mechanism and verify the handset for the intended one of the remote cellular devices. The private routing mechanism then routes the message to the intended one of the remote cellular devices using the association between the handset and the remote cellular device using the private phone number.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of an embodiment of a system for communicating with multiple mobile units using SMS, SMPP and other protocols;

FIG. 2 is a block diagram of an embodiment of an M2M device according to the concepts described herein; and

FIG. 3 is a flow chart for an embodiment of a method for routing SMS messages to remote devices using private numbers.

### DETAILED DESCRIPTION OF THE INVENTION

The concepts described herein provides a system and method to allow consumer handsets to send an SMS to an SMS Private Routing mechanism which will then forward the message to the private, non-PSTN routable phone number assigned to cellular subscription using the direct, private programmatic interfaces for that service provider. The invention combines the use of a standard cellular short code with a concept of associating the consumer handset with one or more M2M cellular subscriptions/devices to enable this capability. The consumer handset sends an SMS to a short code which is delivered to the SMS Private Routing mechanism which then uses a pre-assigned association between the handset and the M2M device to route the SMS to the M2M cellular device using the private phone number.

It has not been possible to send an SMS directly to a device using an M2M cellular subscription from a consumer cellular handset if the M2M cellular subscription was assigned a non-dialable, private phone number (i.e. 555-xxx-xxxx type number). Many M2M service providers and integrators use SMS from handsets to communicate with their M2M devices for diagnostics, or feature capability (i.e. arm/disarm a security panel via SMS). This required customers to develop backend data or web service interfaces to a service provider instead of using the standard SMS capability in a public network which is not economically feasible for many M2M service providers. With this mechanism, any consumer, public handset can send an SMS over the public SMS network using a short code and have it delivered to a device using a private, non-dialable phone number. This allows M2M service providers to use SMS to communicate directly with the M2M devices but retain the security and independence on a limited set of dialable phone numbers.

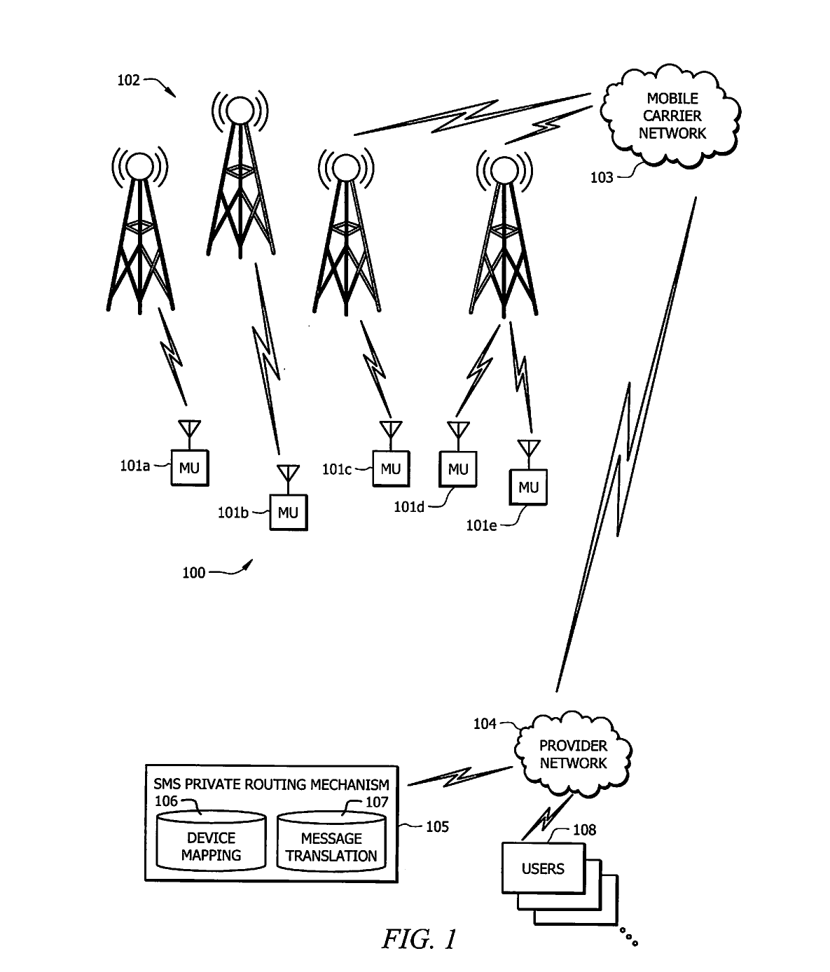

Referring now to FIG. 1, the present invention describes an embodiment of a system 100 for monitoring the communications of a large number of remote or mobile units 101a through 101e that are programmed to report location, data and/or status periodically, in response to an event, or in response to a request by a monitoring center. Each mobile unit is assigned a non-dialable, private phone number that it uses to communicate to cellular network 102. Cellular network 102 is connected to the mobile carrier network 103 using a Web Service or SMPP specific to that cellular provider.

Since the mobile units 101a through 101e use private numbers, they are not accessible from a traditional handset using a normal provider network 104 using SMS or any other traditional handset protocol. In order to allow users 108 to send and receive messages with the mobile units 101a through 101e, the present invention allows the users 108 to use a SMS Private Routing Mechanism 105 to communicate with the mobile units. Private Routing Mechanism 105 takes traditional SMS messages or messages using other protocols and converts them into messages routable on the private or SMPP network 103. Private Routing Mechanism controls access to the mobile units 101a-101e by mapping user devices to particular mobile units using device mapping database 106. Device mapping database 106 acts as an allowed-to-communicate filter preventing random or unauthorized devices from communicating with the mobile units. Private Routing Mechanism 105 also may include a message translation function to translate SMS or other messages into a format receivable by the mobile units and vise versa. The translation function could also take place elsewhere in the network.

The protocols used in preferred embodiments of the system are agnostic to technical details of the specific devices and can be used across a spectrum of devices and technologies. While a particular number of mobile units are represented in FIG. 1, any number of mobile units can be accommodated using the concepts described herein.

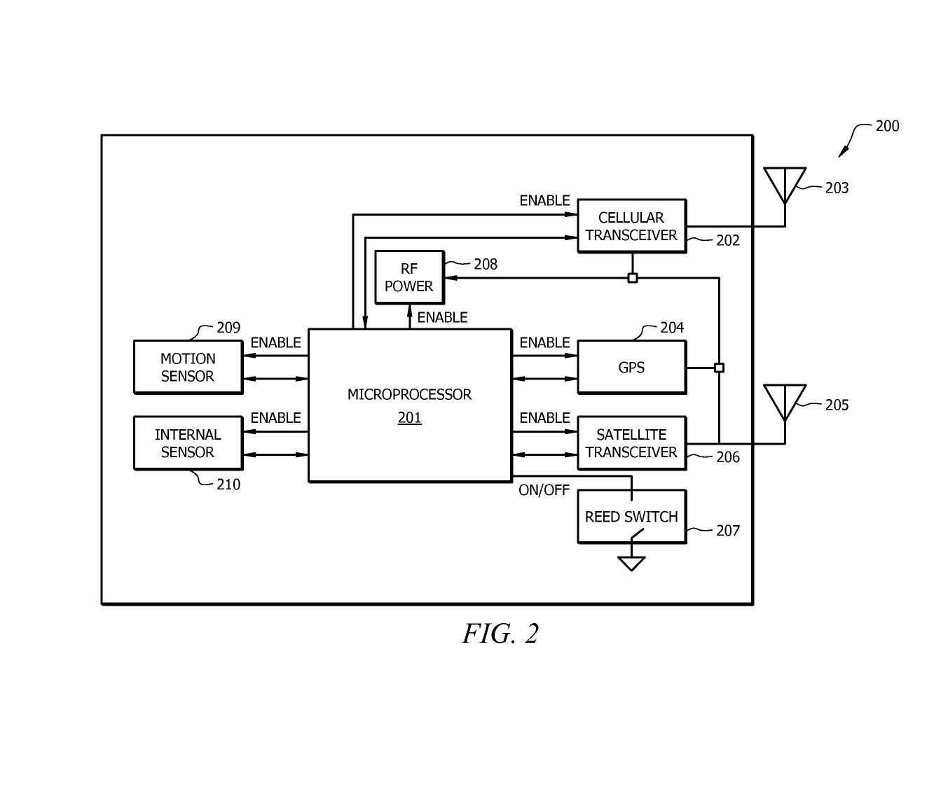

Referring now to FIG. 2, an embodiment of a remote or mobile unit is described. The unit 200 includes a microprocessor 201 programmable to execute desired instructions and to control the operation of unit 200. The processor 201 may have internal memory capable of storing data and programming information or may use memory external to the microprocessor. The unit 200 also includes a cellular transceiver 202 and associated cellular antenna 203 to perform cellular communications. Power for the cellular transceiver is supplied by RF power module 208. The unit 200 may also include a satellite location determination device 204, which can be GPS or satellite service based, and a satellite transmitter, receiver or transceiver 206, which uses satellite antenna 205.

Sensors 209, 210 can be embedded in or connected to the device to collect data, detect motion, detect the presence of another object, or any other type of data or environmental information. Such information can be collected and reported to the data center or can also be used to trigger actions by the mobile device. Reed switch 207 is an electrical switch that is activated by a magnetic field and can be used to enable or disable the device. While unit 200 is shown with a particular combination of sensors and communication elements, the specific configuration of each device can vary according to its intended use and may include a particular sensor or array of sensors, may include one communications system or multiple communications systems, and may include any of a variety of location determination modules or none at all.

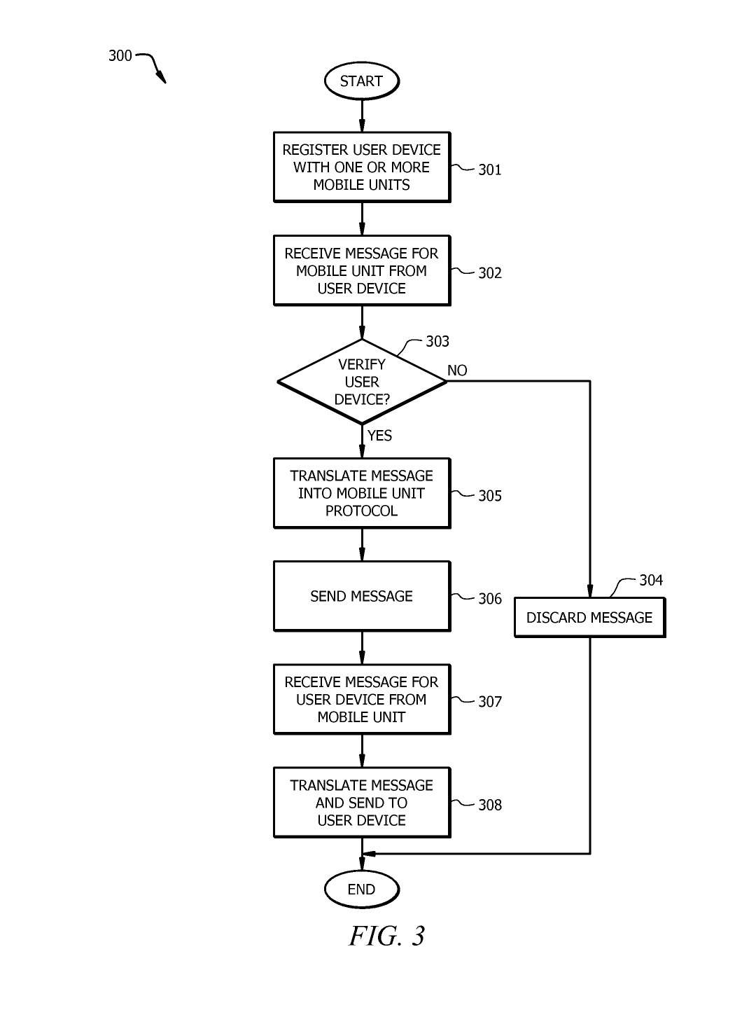

Referring now to FIG. 3, an embodiment of a method for allowing a private number mobile device to communicate with a user handset is described. Method 300 is preferably implemented by a private routing mechanism such as private routing mechanism 105 described with respect to FIG. 1. Method 300 begins with the registering of a user device and associating that user device with one or more mobile units, shown in step 301. Allowing only registered devices prevents random or unauthorized devices from communicating with the mobile units. In step 302, a message is received from a user device intended for one of the mobile units. In step 303, the user device is verified to make sure it is authorized to communicate with the intended mobile device. If it is not authorized the message is discarded, as shown by step 304. If it is authorized, the message is translated into the appropriate protocol, if required, as shown by step 305. The message is then sent to the mobile unit as shown in step 306. If the mobile unit sends a return message, as shown by step 307, that message is translated as required and sent on to the user device as shown by step 308.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of sending a message to a remote cellular device having a non-dialable number, the method comprising:
associating a user handset with one or more remote cellular devices having a non-dialable number;
receiving a message from the handset intended for one of the remote cellular devices at a private routing mechanism;
verifying the association between handset and the intended one of the remote cellular devices; and
routing the message to the intended one of the remote cellular devices using the association between the handset and the remote cellular device using the private phone number.

2. The method of claim 1 wherein the handset uses a standard cellular short code to send a message to the intended remote cellular device.

3. The method of claim 1 wherein the message uses a Short Message Service (SMS) protocol.

4. The method of claim 1 wherein messages from unverified devices are discarded.

5. The method of claim 1 further comprising translating the message into a protocol used by the remote cellular device.

6. The method of claim 1 further comprising receiving a return message from the intended remote cellular device; and sending the return message to the handset.

7. The method of claim 6 further comprising translating the message into a protocol used by the user handset.

8. The method of claim 1 wherein communication with the remote cellular devices uses a Short Message Peer-to-Peer (SMPP) protocol.

9. The method of claim 1 wherein the private routing mechanism includes a device mapping database used to store the association between the user handset and the one or more remote cellular devices.

10. The method of claim 1 wherein private routing mechanism includes a translation database to translate the message into the protocol used by the intended remote cellular device.

11. A private routing mechanism for sending a message to a remote cellular device having a non-dialable number, the private routing mechanism comprising:
a device mapping database storing associations between a user handset and one or more remote cellular devices each having a non-dialable number;
wherein the private routing mechanism receives a message from the handset intended for one of the remote cellular devices at a private routing mechanism; verifies the handset for the intended one of the remote cellular devices; and routes the message to the intended one of the remote cellular devices using the association between the handset and the remote cellular device using the private phone number.

12. The private routing mechanism of claim 11 wherein the handset uses a standard cellular short code to send a message to the intended remote cellular device.

13. The private routing mechanism of claim 11 wherein the message uses a Short Message Service (SMS) protocol.

14. The private routing mechanism of claim 11 wherein messages from unverified devices are discarded.

15. The private routing mechanism of claim 11 further comprising a message translation function that translates the message into a protocol used by the remote cellular device.

16. The private routing mechanism of claim 11 wherein the private routing mechanism is further operable to receive a return message from the intended remote cellular device; and to send the return message to the handset.

17. The private routing mechanism of claim 16 wherein the private routing mechanism is further operable to translate the message into a protocol used by the user handset.

18. The private routing mechanism of claim 11 wherein communication with the remote cellular devices uses a Short Message Peer-to-Peer (SMPP) protocol.
